(19) United States
(12) Patent Application Publication
(10) Pub. No.: US 2008/0209827 A1
(43) Pub. Date: Sep. 4, 2008

(54) Temporary movable/removable compression partition wall system

(76) Inventor: Scott T. Webb, Babylon, NY (US)

Correspondence Address: ABELMAN, FRAYNE & SCHWAB, 666 THIRD AVENUE, 10TH FLOOR, NEW YORK, NY, 10017, US

(21) Appl. No.: 12/009,311

(22) Filed: Jan. 16, 2008

Related U.S. Application Data
(60) Provisional application No. 60/880,890, filed on Jan. 16, 2007.

(51) Int. Cl. E06B 9/06

(52) U.S. Cl. 52/220.7

(57) ABSTRACT

A temporary movable/removable compression partition wall system for partitioning a room includes a wall component and spaced-apart pressure feet at the top of the wall for pressing against a track positioned between the top of the wall and the ceiling and additional spaced-apart pressure feet at the bottom of the wall for pressing against a track positioned between the bottom of the wall and the floor. This wall is temporarily, securely and rigidly positionable at a selected location in a room and subsequently removable with substantially no damage to the ceiling, floor or walls.

### BACKGROUND

1. Field of the Invention

The field of this invention is partition wall systems where a temporary wall is positioned to partition a room into separated parts. Such systems are applicable and highly useful in residential apartments and homes, lofts, offices, theaters, schools, hospitals, gymnasiums and other institutional, commercial and industrial buildings.

2. Prior Art

Need for temporary partitioning of space occurs in countless situations, as when separate spaces are needed within a given room or when a particular room is too large for the desired use, and specifically in residential apartments and homes where the total space is limited and within that space an additional bedroom, storage, den or other work space is temporarily needed.

As indicated above, the field of this invention is temporary partition wall systems where it is contemplated that a temporary wall will, at a future date, be removed or moved. Common and typical problems associated with temporary removable walls, or partition walls generally, in the prior art include:

1. Residual damage to the ceiling, floor and/or walls after removal of the temporary wall, requiring plastering, painting and/or other surface repairs and finishing.

2. The expensive cost of assembly and erection of temporary walls because of the requirement for a professional installer.

3. The expensive cost of the temporary wall components.

4. The cost of transporting and/or storing the relatively heavy wall components.

5. The difficulty or impossibility for residential tenants to do their own assembly because it is too heavy and/or complicated.

6. The difficulty and high cost to apply finish molding at the ceiling, floor and walls to achieve a finished appearance.

7. The difficulty to achieve strength, stability and sound-proofing.

8. The fact that typical prior art temporary walls either do not include internal wiring or pre-formed door frames or windows.

9. Height limitations of prior art temporary walls.

In summary, there is a very great need for temporary walls in residential institutional, entertainment, and commercial buildings, and there are many undesirable costs, difficulties and downsides associated with such walls. Interested persons must either accept the collection of advantages and disadvantages or else do without the temporary walls. The new temporary movable/removable compression partition system overcomes or reduces most of the above-described problems in prior art partition systems.

### SUMMARY OF THE NEW INVENTION

The new compression partition wall system includes all or various combinations of the following features and advantages:

1. The walls of this partition system comprise lightweight material, so that a professional or non-professional average homeowner can handle, move and install the walls. A typical new wall panel will weigh about 50 pounds compared to a typical prior art panel which weight 130 pounds.

2. This partition wall employs a compression system so that fasteners to the ceiling, floor and wall are not needed. Therefore, damage is not caused to these surfaces and repair to said surfaces is not required when the partition is removed.

3. This compression wall system, also called “Pressure Lock System”, includes tracks at the ceiling and on the floor respectively above and below the temporary wall. Pressure feet extending upward and downward respectively from the top and bottom of the temporary wall, press against the two tracks to level and tightly and securely stabilize the wall with respect to the ceiling and floor. Each pressure foot is axially adjustable to adjust the wall elevation position and to achieve horizontal stability, thus maintaining the wall in its vertical orientation and in its lateral (north, south, east and west) location. The tracks are preferably channel-shaped, but may alternatively be generally flat, thin planks.

4. The new temporary compression wall is constructed of a plurality of panels which are normally eight feet high for typical eight feet high ceilings by four feet wide, but these dimensions may vary. To form a wall, vertically oriented panels are placed edge-to-edge and removably joined together. In a preferred embodiment an I-beam serves as the junction element, with adjacent side edges of adjacent panels positioned in one of the opposite channel-shaped sides of the I-beam. Along the top and bottom of each panel is secured a horizontal channel having integrated threads (threaded holes) to receive threaded shanks of the pressure feet. Thus, the vertical pressure is applied along the horizontal length of each panel to both the ceiling and the floor surfaces without causing any damage to these surfaces.

5. This new temporary wall system can also be used in lofts or locations where the ceilings are exceptionally high, by attaching piggyback panels to the standard height partitions.

It is thus an object of this invention to provide an improved temporary movable/removable partition wall system which does not damage the ceiling or floor when installed.

It is a further object of this invention to provide a temporary partition wall system which is removably secured in a selected location by using axially adjustable pressure feet that extend toward the ceiling and the floor. In a preferred embodiment a ceiling track is positioned between the ceiling and upper pressure feet, and a floor track is positioned between the floor and the lower pressure feet.

An additional object is to provide a temporary compression partition wall formed of light weight panels that can be easily and quickly connected by their side edges to have a wall of desired length. In a preferred embodiment each two adjacent panel edges fit into opposite sides of a vertical I-beam with removable biscuits extending through slots in the web of the I-beam and into slots in the side edges of the panels. It is an additional object to provide a temporary wall system that can be handled, installed, removed and stored by both non-professionals and by professionals.

These and other objects of the invention will be further understood and appreciated by those skilled in the art by reference to the following written specification, claims and appended drawings.

### BRIEF DESCRIPTION OF THE DRAWINGS

FIG. 1 is a fragmentary elevation view of the temporary partition of this invention shown installed to the ceiling, floor and walls of a room.

FIG. 2 is a top plan view in partial section taken along line 2-2 in FIG. 1, showing one end of the new partitioned wall adjacent a permanent wall.

FIG. 3 is a fragmentary elevation view in section taken along line 3-3 in FIG. 1, showing a top portion of the new partitioned wall adjacent to the ceiling.

FIG. 4 is a fragmentary elevation view in section taken along line 4-4 in FIG. 1, showing a bottom portion of the new partitioned wall adjacent to the floor.

FIG. 5 is a fragmentary elevation view in section taken along line 5-5 in FIG. 1, showing a top portion of the header panel above the door frame adjacent to the ceiling.

FIG. 6 is a fragmentary top plan view in section taken along line 6-6 in FIG. 1, showing the attached side edges of two adjacent panels.

FIG. 7 is a fragmentary top plan view partially in section taken along line 7-7 in FIG. 3, showing a wrench applied to one of the pressure feet.

FIG. 8 is a fragmentary elevation view in section taken along line 8-8 in FIG. 6, showing the connection of adjacent side edges of two adjacent panels.

FIG. 9 is a fragmentary perspective exploded view of a new temporary compression partition wall of this invention, including attached partitions and pressure feet at the top and bottom thereof and ceiling and floor tracks.

FIG. 10 is a fragmentary exploded perspective view enlarged of an upper portion of the assembly of FIG. 9.

FIG. 11 is a fragmentary elevation view of a new temporary wall similar to FIG. 1, but showing interlocking piggyback panels attached to the tops of regular panels for a partition wall having a height greater than the standard eight feet.

FIG. 12 is a fragmentary top plan view in section taken along line 12-12 in FIG. 11, of an end post portion of the partitioned wall.

FIG. 13 is a fragmentary elevation view in section taken along line 13-13 in FIG. 11, showing at the top of the connection of the upper part of the wall to the ceiling and at the bottom showing the connection of the piggyback panel to the basic panel.

FIG. 14 is a fragmentary elevation view in perspective showing a temporary partition wall having a principal part at the right angle to an auxiliary part, thus defining a corner.

FIG. 15 is a fragmentary top plan view in section taken along line 15-15 in FIG. 14, showing the connection of the right angle panels at the corner intersection.

FIG. 15A is a perspective view of the corner junction column for attaching panels at a right angle as seen in FIGS. 14 and 15.

FIG. 16 is a fragmentary elevation view in section taken along line 16-16 in FIG. 15, showing the junction of one right angle panel to the connection column.

FIG. 17 is a fragmentary top plan view in section showing the junction of two adjacent panels along their adjacent side edges.

FIG. 18 is a fragmentary elevation view in section taken along line 18-18 in FIG. 17, showing an alternate version of the coupling biscuit for joining two adjacent panels along their mutual edges.

The features of the invention will become apparent from the following description of the exemplary embodiments taken in conjunction with the accompanying drawings.

### DETAILED DESCRIPTION OF THE PREFERRED EMBODIMENTS

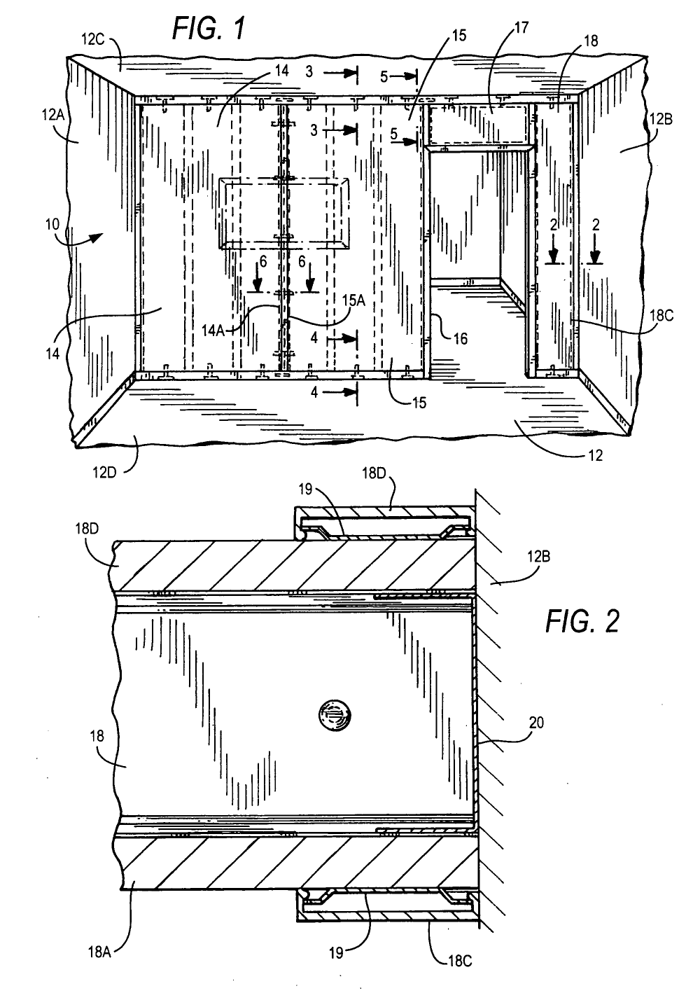

FIG. 1 shows an installation of a temporary pressurized wall 10 of my movable/removable compression partition system where the new wall partitions a room 12 into separate parts. Wall 10 is formed of two 8′×4′ panels 14 and 15, plus door frame 16, header panel 17 above the door frame 16 and filler panel 18. As indicated in FIG. 1, panels 14 and 15 are detachably joined together along their adjacent side edges 14A and 15A, as will be described later in detail. Panel 15 is similarly removably attached to panel 17, and panel 17 is removably attached to panel 18. Room 12 includes side walls 12A and 12B, ceiling 12E and floor 12D. Wall 10 has top part 10A which removably engages ceiling 10C, and bottom part 10B which removably engages floor 12D.

FIG. 2 is a top plan view in section of panel 18 engaging the room's side wall 12B. Panel 18, while narrower than basic panel 14, has certain typical construction features, such as front and rear panel faces 18A and 18B, front and rear bottom (vertical moldings) 18C and 18D, and batten clips 19. Panel 18 also has an end cap, 20 which is a vertical channel 20 extending from top to bottom along the exposed side edge that engages the room's wall 12B.

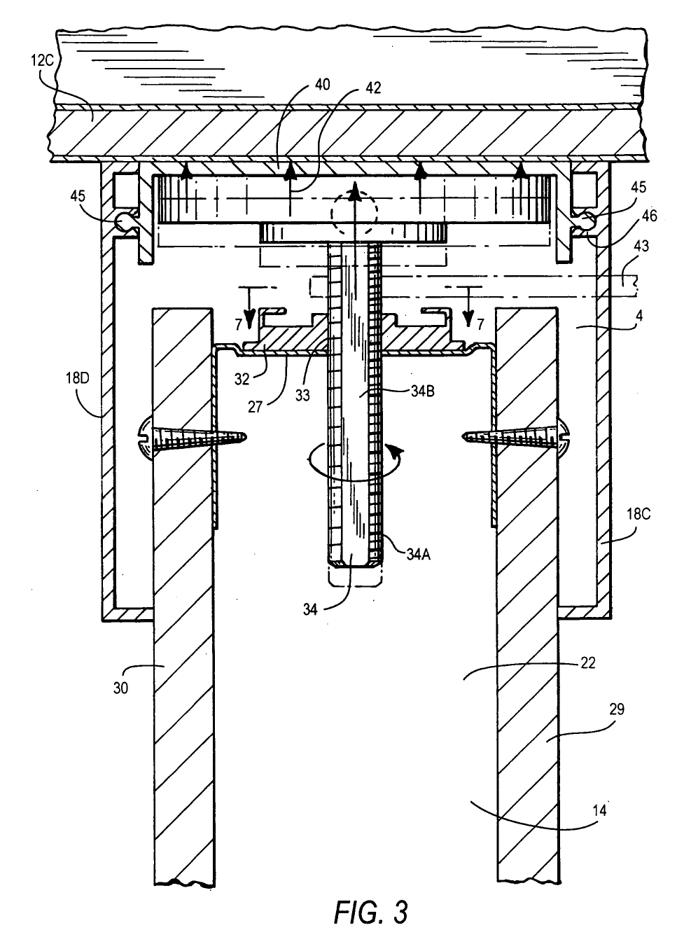

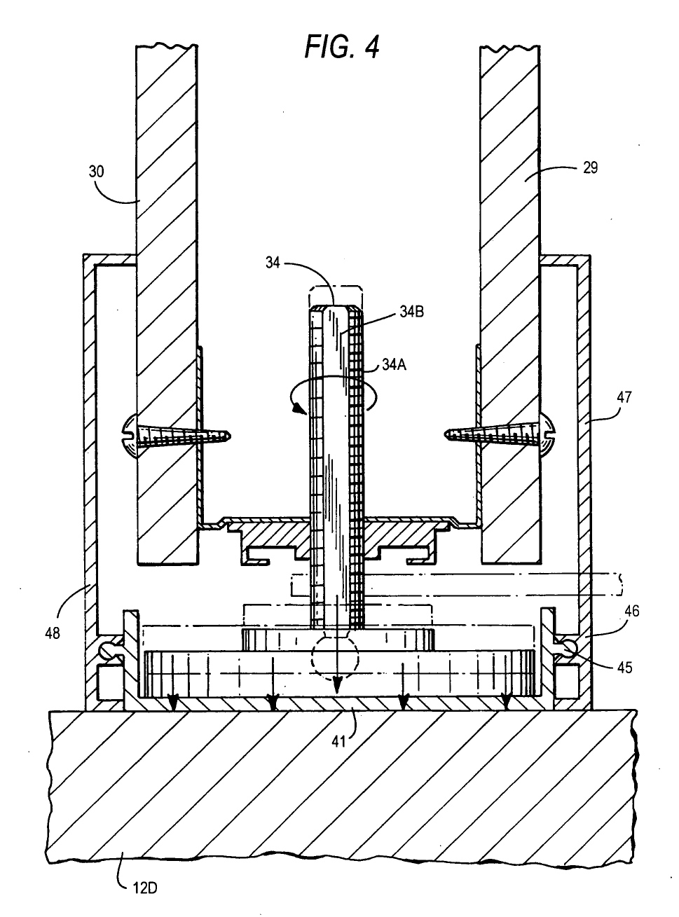

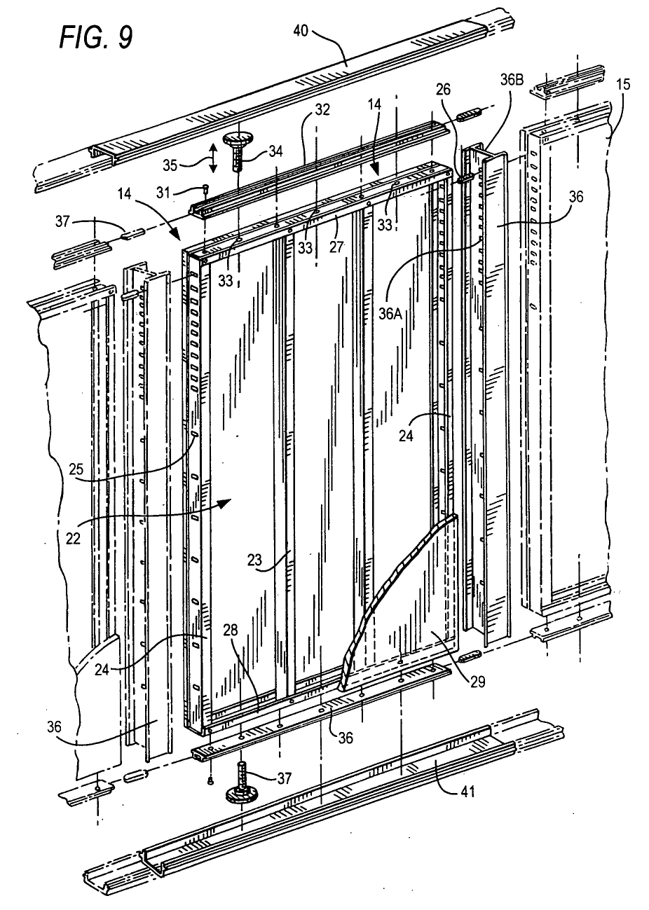

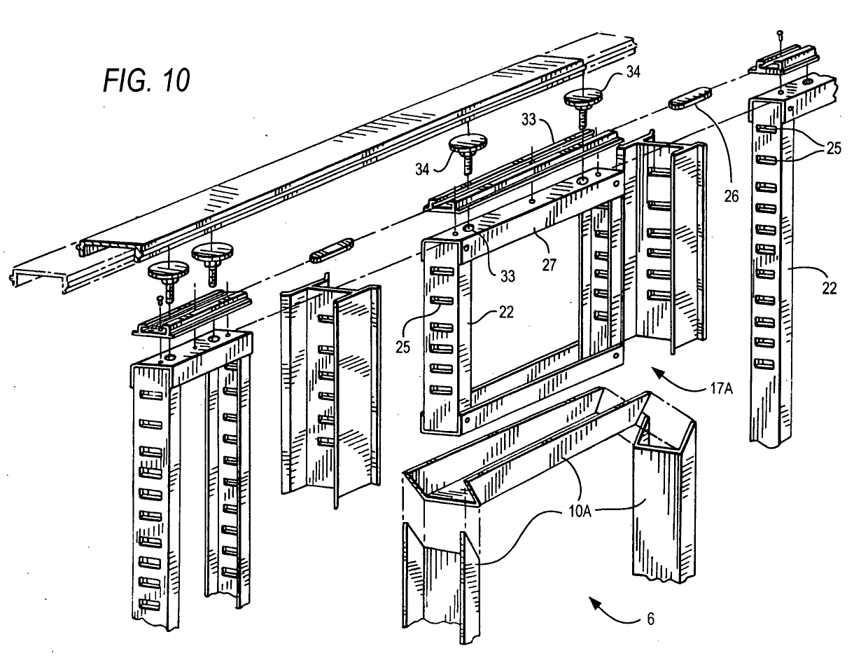

The overall construction of a typical wall panel 14 is seen in FIGS. 9 and 10 as follows. Inner frame 22 comprises vertical inner studs 23 and outer studs 24 usually of aluminum or steel with slots 25 to receive biscuits 26 which will be further described later, for connecting one panel side edge to an adjacent panel side edge. The above-mentioned studs 23 and 24 are coupled to top and bottom beams 27 and 28 by rivets, adhesive or other fastening means to form the basic internal frame. Attached to said inner frame 22 is front panel face 29, rear panel face 30 is not shown in FIG. 9, but is visible in FIGS. 3 and 4. A typical panel comprises an aluminum frame with corrugated cardboard outer skins sold under the name “Miracle Board” by PlyVeneer Products Co. My preferred panel comprises Miracle Board clad with a veneer for a prefinished appearance. The panels are also available with a printable surface for field finishing. All panels are prefabricated, including selected exterior surface, so that they are immediately usable when the wall is assembled and installed.

As seen in FIGS. 9, 10 and 3, secured atop frame 22 by screws 31 is channel track 32 which includes threaded holes 33. In each threaded hole 33 is one pressure foot 34, which when rotated, moves axially upward or downward as indicated by arrow 35. Each of the three threaded holes 33 receives a similar pressure foot 34. At the bottom of frame 22 is bottom channel track 36 which is the same as top channel track 32, but inverted, and which include pressure feet 37, similar to those at the top.

As seen in FIG. 9, panels 14 and 15 are coupled together via slotted I-beam 36 whose channel-shape left side 36A receives an edge of panel 14 and whose channel shape right side 36B receives the edge of panel 15. That coupling is stabilized by the above-mentioned biscuits 26. Other biscuits 37 stabilize the junction of top channel track 32 atop panel 14 with the top channel track of the adjacent and coupled panel 15.

At the time of installation of the new temporary compression wall, floor track 41 is positioned at a desired location on the floor, and ceiling track is situated atop the first wall panel. The bottom edge of this first panel is situated in the floor track, and the panel is pivoted upward with the ceiling track on-board at the top. Or the ceiling track may be independently positioned at the ceiling, until the wall panel is pivoted up to engage it. Ceiling and floor tracks are made of standard commercial rigid PVC. Pressure feet 37 and 34 respectively at the bottom and top of the panels are rotated, applying axial pressure via tracks 40 and 41 to the floor and ceiling until the wall is leveled, secured and stabilized in the desired position. Each panel is stabilized relative to adjacent panels by its coupling via an I-beam 36, in addition to its engagement with the ceiling and to the floor.

FIG. 3 shows in greater detail the engagement of panel 14 with ceiling 12C, where pressure foot 34 applies upward vertical face, indicated by arrows 42 through ceiling track 40 to ceiling 12C.

As seen in FIGS. 3 and 4, each pressure foot 34 has a threaded shank 34A with opposite flats 34B to receive a wrench 43 which is used to rotate the pressure foot and move it axially and apply the upward vertical face against the ceiling. The wrench is used similarly with the bottom pressure feet engaging the floor track.

After pressure feet adjustment is complete, the upper position of panel 14 where the pressure feet are visible is covered by front crown molding 18C and rear crown molding 18D, each being snapped on via horizontal bead projection 45 and mating horizontal groove 46 in crown molding 18C. As seen in FIG. 4, a similar and essentially the same operation and construction is employed at the bottom of the wall, with groove 46 of base molding releasably coupled with projection 45 which extends laterally from floor track 41.

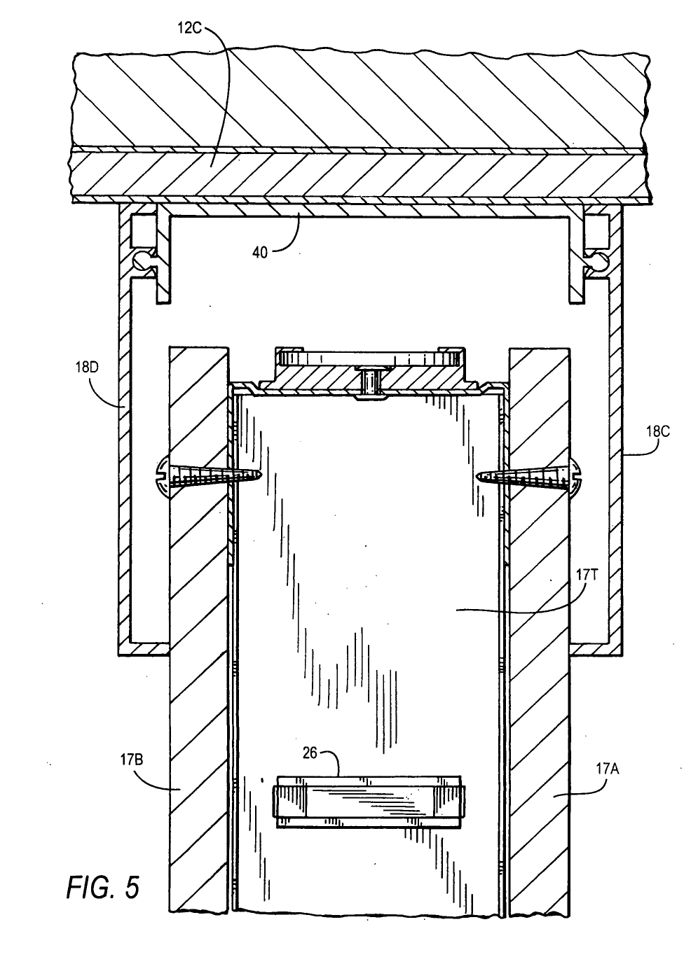

FIG. 1 shows door frame 16 with header panel 17 immediately above the door frame. FIG. 10 shows channel components 10A of door frame 16 and inner frame 17A of header panel 17. FIG. 5 shows the top part 17T of header panel 17 with front and rear faces 17A and 17B, junction biscuit 26 for coupling header panel 17 to adjacent basic panel 15 (not shown here). Ceiling track 40 extends above header panel 17, and front and rear crown moldings 18C and 18D extend across the top part 17T of the header panel. Crown and baseboard moldings are typically of rigid PVC.

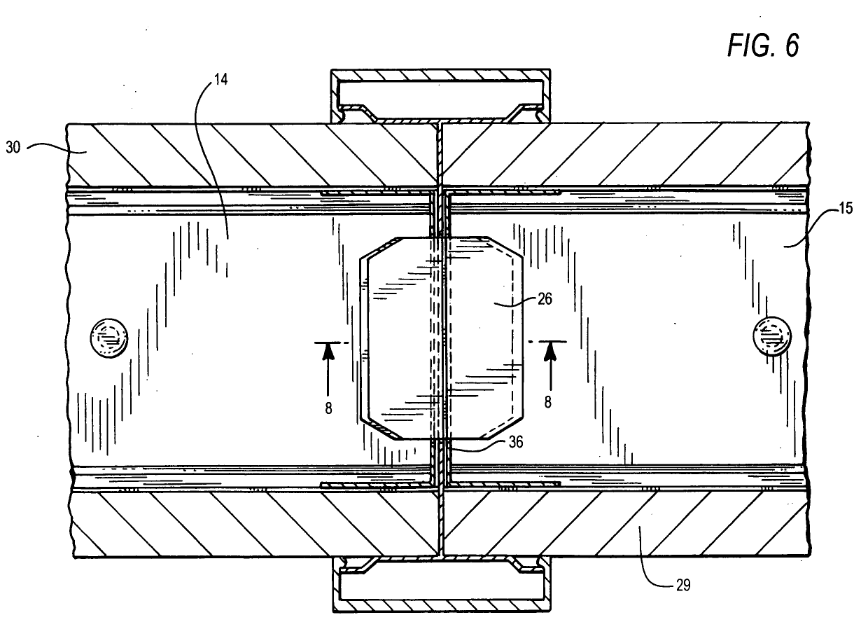

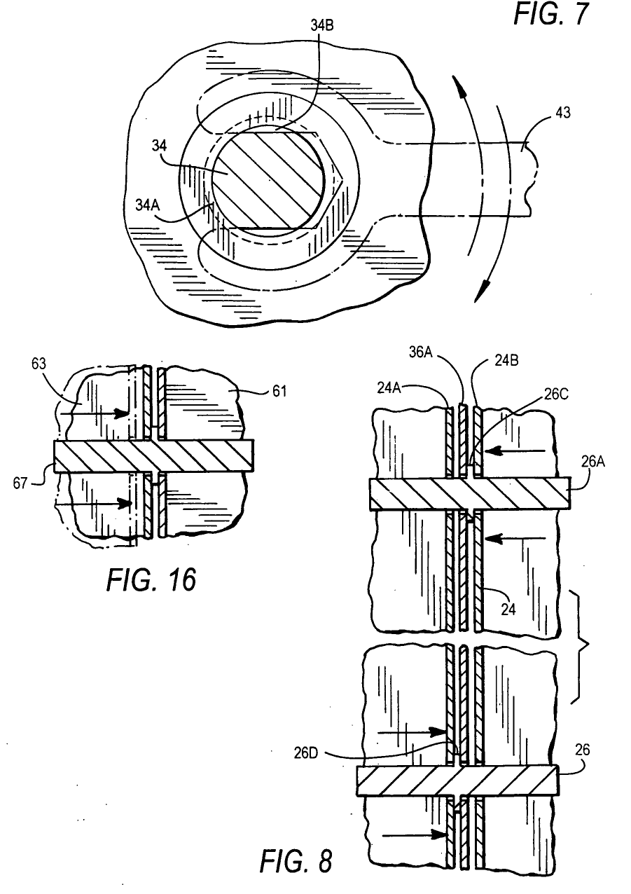

Coupling of adjacent side edges of two panels 14 and 15 is shown in FIGS. 1, 6, 8, and 9. In FIG. 9 slots 25 are visible where they are vertically spaced along each side edge of the panels. For a typical coupling, as seen in FIG. 6, slotted rigid PVC I-beam 36 receives one side edge of each panel into the channel-shaped edge. Each biscuits 26 extends through a slot in I-beam 36 and into aligned slots 25 in the two adjacent panels. The sectional viewed FIG. 8 shows in enlarged sectional detail:

a) Web 36A of slotted I-beam 36.

b) Slotted outside stud 24A of panel 14.

c) Slotted outside stud 24B of panel 15.

d) Upper biscuit 26A.

e) Lower biscuit 26B where a plurality of such biscuits are alternated along the top to bottom length of the panel. Each biscuit has a flange, as flange 26C of biscuit 26A and flange 26D of biscuit 26B. With this arrangement, flange 26C of biscuit 26A, for example, is sandwiched between stud 24B and web 36A of I-beam 36, so that biscuit 26A cannot fall or be pushed out of the position shown, where it has approximately half its length in panel 14 and half in panel 15. Biscuit 26B is similarly situated, except that its flange 26D is on the left side of web 36A. This prevents the biscuits from falling or being pushed out of position, where their presence helps to stabilize the panels relative to each other. Principal stabilization exists mainly from the pressure feet exerting upward and downward forces respectively against the ceiling and floor.

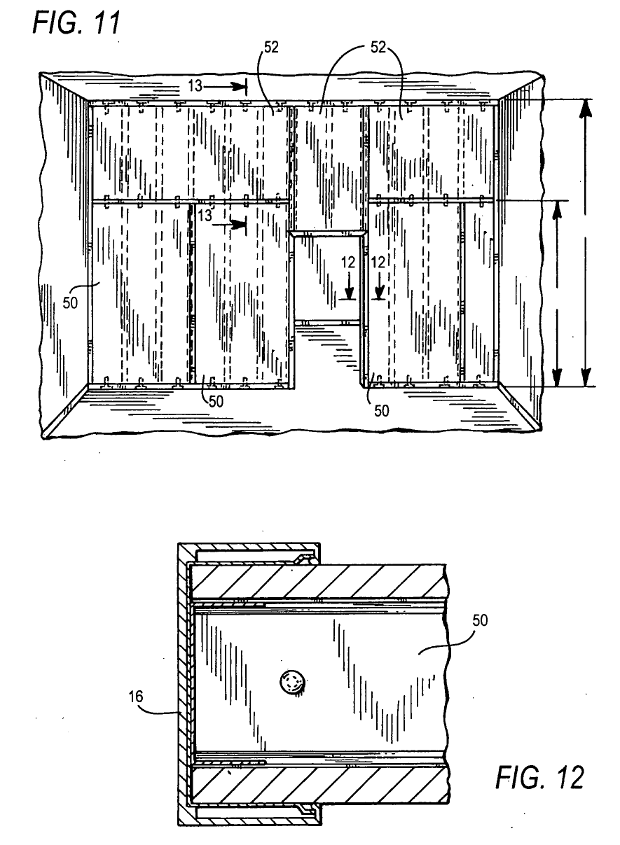

FIGS. 11, 12 and 13 illustrate an extension system where a basic temporary compression wall of this invention can be extended to function in rooms with very high ceilings having the height of twelve feet, for example. The wall of FIG. 11 corresponds generally to the wall of FIG. 1, except that the basic wall panels 50 in FIG. 11 are modified to receive the extension headers (extension header panels) 52. As seen in FIG. 13, the pressure feet 53 are now at the top of extension header 52 and not at the top of basic panel 50. However, in the top channel track 32 of panel 50, the threaded hole 54 is used to receive junction bolt 55 to secure extension panel 52 to basic panel 50. There is a plurality of bolts 55 laterally spaced along the top of panel 50 from side-to-side.

Between panels 50 and 52 is a horizontal I-beam 56 which defines opposite upper and lower channel-shape tracks to receive adjacent edges of said panels. After such junction of panels, battens 57 are clipped on to cover and hide the junction.

The top part of header panel 52 has the previously described pressure feet, later covered by front and rear crown moldings 18C and 18D. FIG. 12 shows the engagement of the side-to-side edge of panel 50 with door frame 16.

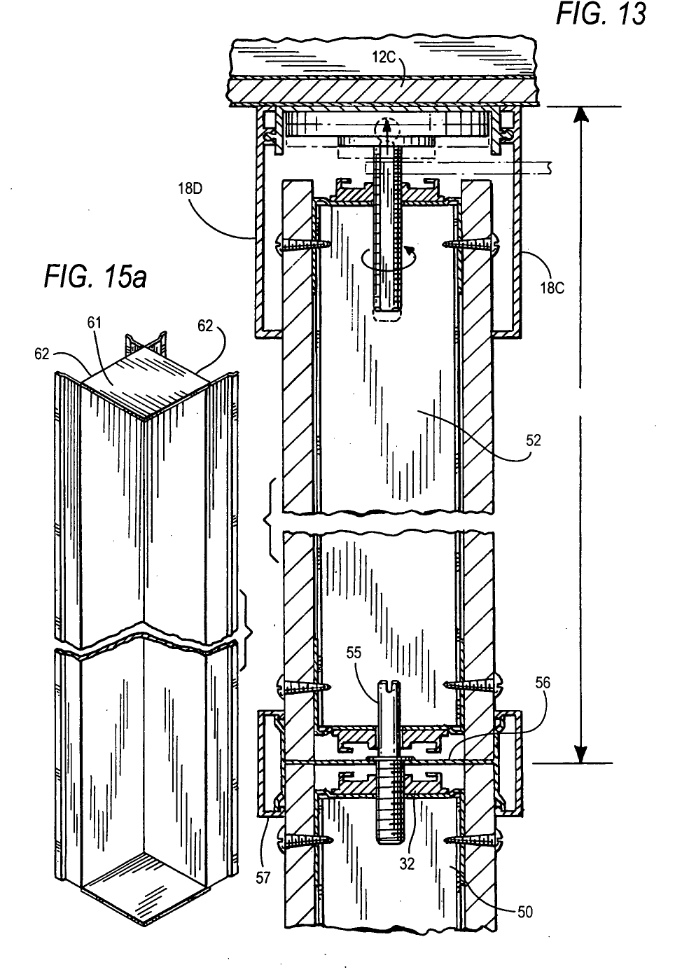

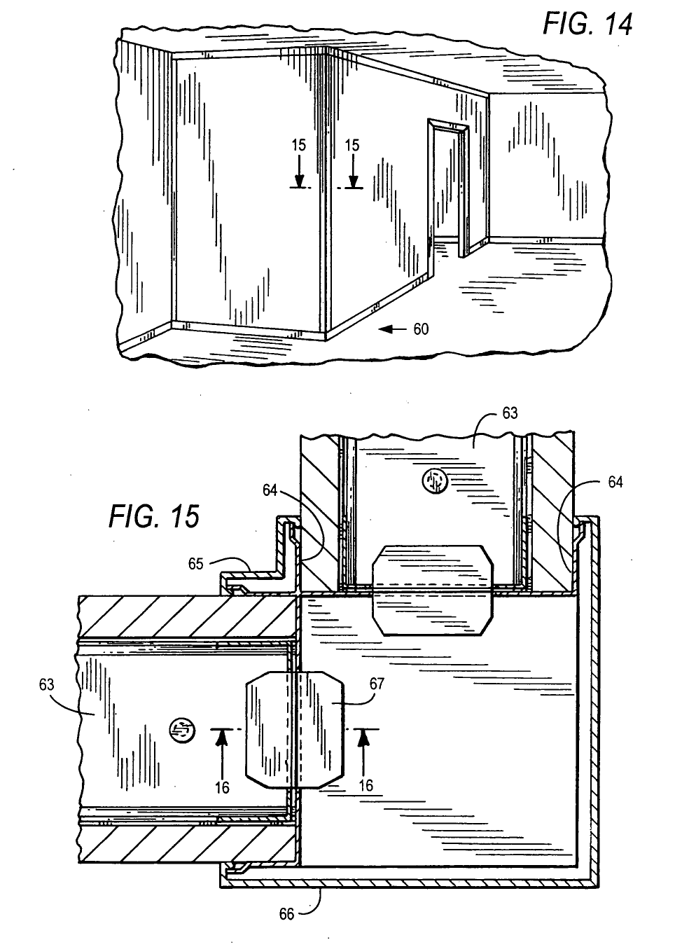

FIGS. 14, 15, 15A and 16 show the construction of the new wall to form a corner 60 with a right angle panel arrangement. The new corner 60 includes a corner column 61, seen in FIGS. 15 and 15A, as a unitary molded element defining vertical channels 62 to receive side edges of panels 63 in the usual manner as described earlier. There are additional vertical ribs 64 molded contiguously with column 61 and serving as batten clips to engage and removably hold vertical inner cosmetic molding 65 and outer cosmetic molding 66. FIG. 16, as a section taken in FIG. 15, shows biscuit 67 between panel 63 and column 61.

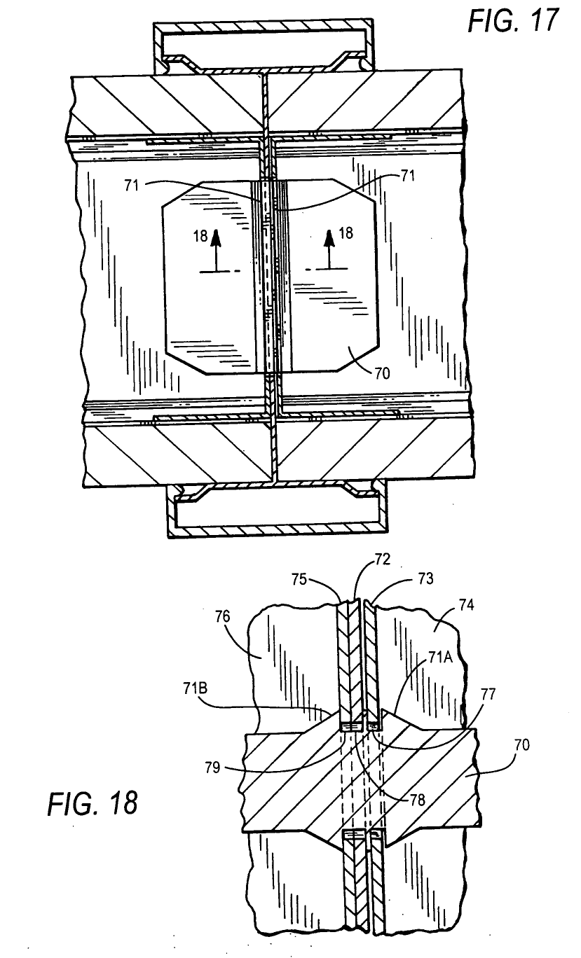

FIGS. 17 and 18 correspond generally to FIGS. 1, 6, and 9 illustrating a second embodiment of biscuit 70 which has tapered resilient flanges 71A and 71B on each side. In these figures, there is slotted I-beam 72, slotted outer stud 73 of panel 74, and slotted outer stud 75 of panel 76. During assembly, biscuit 70 is pushed in the leftward direction through the slot in stud 73, through slot 78 in I-beam 72 and through slot 79 in stud 75. Flange 71A is resiliently deflected in order for biscuit 70 to pass through slots 78 and 79. Then flange 71A bars further lateral movement of biscuit 70 to the left and flange 71B bars lateral movement of biscuit 70 to the right.

The components and materials used in this new temporary wall partition system may vary from the many commercially available products. Preferred materials include PVC for the battens (moldings), PVC for the ceiling and floor tracks, PVC for the crown and base moldings, PVC for the discs of pressure feet, PVC for the stabilizing 1⅝″ thick biscuits 26 between prefabricated panels 14, 15 for vertical stability and 1⅝″ thick aluminum for biscuits 37 between adjacent ends of channel tracks at the ceiling and floor.

While the invention has been described in conjunction with several embodiments, it is to be understood that many alternatives, modifications and variations will be apparent to those skilled in the art in light of the foregoing description. Accordingly, this invention is intended to embrace all such alternatives, modifications and variations which fall within the spirit and scope of the appended claims.

1. A temporary compression wall system for division of a room which has a floor and a ceiling of predetermined height above said floor, said temporary compression wall system in its erected orientation, comprising:
a. at least one generally rectangular panel having a central body part defining a generally vertical plane, said body part having top and bottom edges defining length of said panel in the top-to-bottom direction, and opposite side edges defining width of said panel in the side-to-side direction,
b. an elongated top track positionable against said ceiling,
c. an elongated bottom track positionable against said floor beneath said top track, said at least one panel being positionable between said top and bottom tracks,
d. at least two laterally spaced-apart leveling legs, each being independently axially extendible downward from said bottom edge of said panel for engaging said bottom tracks, and
e. at least two laterally spaced-apart stabilizing arms, each being independently axially extendible upward from said top edge of said panel for engaging said top track,
f. said leveling legs each being adjustable by its axial extendibility to level said panel, and said stabilizing arms each being adjustable by its axial extendibility to apply an upward force from said panel to said top track which transmits said force to said ceiling, with a corresponding reaction force applied to said bottom track and to said floor, thus stabilizing said panel from moving in any direction.

2. A temporary compression wall system according to claim 1, wherein said at least one panel comprises a generally planar body.

3. A temporary compression wall system according to claim 1, wherein said at least one panel and one of said extendible height leveling legs and one of said stabilizer arms have combined height corresponding generally to said predetermined floor-to-ceiling height of said room.

4. A temporary compression wall system according to claim 1, wherein said leveling legs and stabilizer arms are situated within said vertical plane of said panel.

5. A temporary compression wall system according to claim 1, for use with a room that has an extended floor-to-ceiling height greater than said predetermined floor-to-ceiling height, further comprising a piggy-back panel secured atop said panel, where said panel, piggy-back panel, leveling leg and stabilizer arm have a combined height corresponding generally to said extended floor-to-ceiling height.

6. A temporary compression wall system according to claim 1, wherein said wall system comprises at least two of said panels situated in a generally coplanar relationship with their adjacent side edges securable together, each of said panels having its respective leveling feet and stabilizing arms engagable to a respective top and bottom track.

7. A temporary compression wall system according to claim 6, wherein said top tracks for each of said at least two panels comprise a single contiguous track, and said bottom tracks for each of said at least two panels comprise a single contiguous track.

8. A temporary compression wall system according to claim 1, wherein each of said leveling legs and stabilizer arms comprises a stem having one end engagable to said bottom and top edges respectively of said panels, and an opposite end for threadedly engaging said bottom and top tracks respectively.

9. A temporary compression wall system according to claim 1, wherein each of said panels comprises:
a. two sheets in parallel spaced-apart and overlying planes, each of said sheets having a top edge, a bottom edge and opposite side edges,
b. core means between and fixed to said sheets, maintaining them in said parallel and spaced-apart relationship,
c. a top beam extending generally horizontally and fixed to said top edges of said sheets, said top beam supporting said stabilizer arms, and
d. a bottom beam extending generally horizontally and fixed to said bottom edges of said sheets, said bottom beam supporting said leveling legs.

10. A temporary compression wall system according to claim 9, wherein each of said leveling legs and stabilizer arms comprises a stem having a distal end engagable to said bottom and top edges respectively of said panels, and an opposite proximal end for threadedly engaging said bottom and top tracks respectively, and said top beam has at least one threaded hole extending generally vertically for receiving therein said threaded proximal end of each of said leveling legs, and said bottom beam has at least one threaded hole extending generally vertically for receiving therein said proximal threaded end of one of said stabilizing arms.

11. A temporary compression wall system according to claim 10, wherein each of said stems has external shoulders adjacent said distal end, said shoulders being shaped with spaced-apart flats to be readily engagable by an open-end wrench.

12. A temporary compression wall system according to claim 9, wherein each of said top and bottom beams defines in cross-sectional a generally C-shaped channel.

13. A temporary compression wall system according to claim 1,
a. wherein each of said panels has in its bottom edge at least two laterally spaced-apart threaded holes, each with a generally vertical axis and each of said leveling legs comprises a threaded rod
(i) threadedly engaged in one of said holes,
(ii) having a bottom end for engaging said bottom track, and
(iii) having an external side surface adapted to be engaged for rotation of said bolt, and
b. wherein each of said panels has at its top edge at least two laterally spaced-apart threaded holes, each with a generally vertical axis and each of said stabilizing arms comprises a threaded rod
(i) threadedly engaged in one of said holes, and
(ii) having a top end for engaging said top track, and
(iii) having an external side surface adapted to be engaged for rotation of said bolt.

14. A temporary compression wall system according to claim 9, wherein said core comprises a plurality of horizontally spaced vertically oriented beams, and top and bottom horizontal beams which are fixed to top and bottom ends of said vertical beams.

15. A temporary compression wall system according to claim 14, further comprising at least one vertically oriented I-beam defining opposite vertically extending channels, each channel adapted to receive said side edge of one of said adjacent panels when two of said panels are positioned in co-planar and edge-to-edge relationship.

16. A temporary compression wall system according to claim 15, wherein said vertically oriented beams include edge beams at the outer side edges of said core with vertically-spaced horizontally extending slots in each edge beam, further comprising a plurality of generally flat biscuits slidable through said slots in said I-beam, with ends each biscuit slidable into a corresponding slot in one of said edge beams.

17. A temporary compression wall system according to claim 1, wherein each of said top and bottom tracks defines in cross-section a generally C-shaped channel with the legs of the channel extending away from said ceiling and floor respectively.

18. A temporary compression wall system according to claim 1, further comprising horizontally extending top molding strips releasably securable to said top edge of said panel on each side thereof for covering from sight said top track and said stabilizing arms, and horizontally extending bottom molding strips releasably securable to said bottom edge of said panel on each side thereof for covering from sight said bottom track and said leveling legs.

19. A temporary compression wall kit for division of a room which has a floor and a ceiling of predetermined height above said floor, said temporary compression wall system in its erected orientation, comprising:
a. at least one generally rectangular panel having a central body part defining a generally vertical plane, said body part having top and bottom edges defining length of said panel in the top-to-bottom direction, and opposite side edges defining width of said panel in the side-to-side direction,
b. an elongated top track positioned against said ceiling,
c. an elongated bottom track positioned against said floor beneath said top track, said at least one panel being positioned between said top and bottom tracks,
d. at least two laterally spaced-apart leveling legs, each being independently axially extended downward from said bottom edge of said panel for engaging said bottom tracks, and
e. at least two laterally spaced-apart stabilizing arms, each being independently axially extended upward from said top edge of said panel for engaging said top track,
f. said leveling legs each being adjusted by its axial extendibility to level said panel, and said stabilizing arms each being adjusted by its axial extendibility to apply an upward force from said panel to said top track which transmits said force to said ceiling, with a corresponding reaction force applied to said bottom track and to said floor, thus stabilizing said panel from moving in any direction.

20. A temporary compression wall system for division of a room which has a floor and a ceiling of predetermined height above said floor, said temporary compression wall system in its erected orientation, comprising:
a. at least one generally rectangular panel having a central body part defining a vertical plane, said panel having a top and bottom edges defining length of said panel in the top-to-bottom direction, and opposite side edges defining width of said panel in the side-to-side direction,
b. an elongated top track positioned against said ceiling,
c. an elongated bottom track positioned against said floor beneath said top track, said at least one panel being positioned between said top and bottom tracks,
d. leveling means being extendable downward from said bottom edge of said panel for engaging said bottom track and for selectively lifting and/or leveling said panel to a selected elevation and verticality respectively relative to said floor and ceiling, and
e. stabilizing means being extendable upward from said top edge of said panel for engaging said top track to apply an upward force from said panel to said top track which transmits said force to said ceiling, with a corresponding reaction force applied to said bottom track and to said floor, thus stabilizing said panel from moving in any direction.
